(19) United States
(12) Patent Application Publication
(10) Pub. No.: US 2019/0082878 A1
(43) Pub. Date: Mar. 21, 2019

(54) FOOD PREPARATION METHOD

(71) Applicants: SERGEY KOROTKOV, London (GB); Petr KOROTKOV, Ioshkar-Ola (RU)

(72) Inventors: SERGEY KOROTKOV, London (GB); Petr KOROTKOV, Ioshkar-Ola (RU)

(21) Appl. No.: 16/068,997

(22) PCT Filed: Dec. 23, 2016
(86) PCT No.: PCT/RU2016/000914

§ 371 Date: Jul. 10, 2018

(30) Foreign Application Priority Data
Jan. 12, 2016 (RU) 2016100777

(51) Int. Cl. A47J 27/21

(52) U.S. Cl. CPC A47J 27/21183

(57) ABSTRACT

The invention relates to food preparation methods. The technical result of implementing the invention consists in reducing the amount of energy and time necessary for heating water. The technical result is achieved by dividing water located in kitchenware after a certain a period of time into a portion to be heated and other water.

### CROSS REFERENCE TO RELATED APPLICATIONS

This application relates to, and claims priority from, PCT Ser. No.: PCT/RU2016/000914 filed Dec. 23, 2016, the entire contents of which are incorporated herein by reference, which in turn claims priority from RU Ser. No.: 2016100777 filed Jan. 12, 2016.

### FIGURE SELECTED FOR PUBLICATION

FIG. 1.

### BACKGROUND OF THE INVENTION

### Field of the Invention

The present invention relates to food preparation methods. More particularly, the present invention provides a a method wherein the technical result is achieved by dividing water, located in kitchenware, into a portion to be heated and other water.

### Description of the Related Art

Industrial applications of known food preparation methods occur when water is heated in a boiling-resistant container or vessel, such as a teakettle, and then, a desired amount thereof is used. The drawbacks of this known method are the need to heat the whole amount of water even if only some of it is needed for preparation; or the need to pour off some of the water that does not need to be heated, or the need for multiple refills of the vessel with only the amount of water that is needed to be heated.

Heating, and especially multiple re-heatings, of the entire amount of water regardless of the desired volume results in increased energy consumption, extended heating time, and a shortened lifetime of the vessel. Multiple vessel refills with only the desired amount of water or pouring off the water that does not need to be heated are inconvenient for use and more time is consumed.

Accordingly, there is a need for an improved food preparation method.

### ASPECTS AND SUMMARY OF THE INVENTION

In response, it is now recognized that there is a need for an improved food preparation method.

According to one aspect of the present invention, there is provided a food preparation method, wherein the technical results of implementing the invention consists in reducing the amount of energy and time necessary for heating water. The technical result is achieved by dividing water, located in kitchenware, into a portion to be heated and other water.

The above and other aspects, features and advantages of the present invention will become apparent from the following description read in conjunction with the accompanying drawings, in which like reference numerals designate the same elements.

### BRIEF DESCRIPTION OF THE DRAWINGS

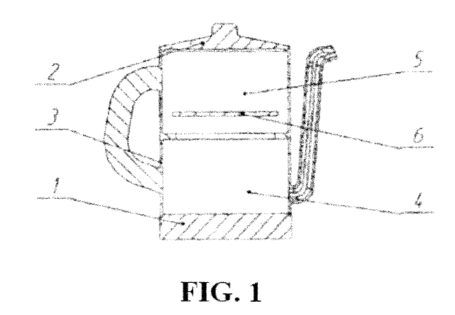

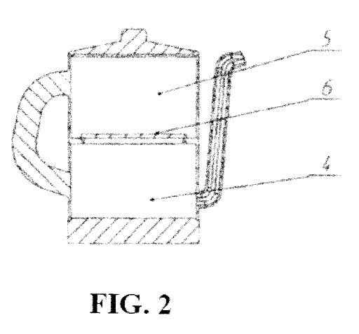

FIG. 1 is a longitudinal cross section illustration of a teakettle.

FIG. 2 is a longitudinal section of the teakettle of FIG. 1 with a shifted and closed screen.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

In the present text, numerous specific details are set forth in order to provide a thorough understanding of exemplary versions of the present invention. It will be apparent, however, to one skilled in the art, that some versions of the present invention may possibly be practiced without some of these specific details. Indeed, reference in this specification to “a variant,” “variants,” and “one/the variant,” or “one version,” “a version” and the like, should be understood to mean that a particular feature, structure, or characteristic described in connection with the variant or version is included in at least one such variant or version according to the disclosure. Thus, the appearances of phrases such as “in one variant,” “in one version,” and the like, in various places in the specification are not necessarily all referring to the same version or variant, nor are separate or alternative versions or variants mutually exclusive of other versions or variants. Moreover, various features may be described which possibly may be exhibited by some variants or versions and not by others. Similarly, various requirements are described which may be requirements for some variants or versions, but not others. Furthermore, as used throughout this specification, the terms ‘a’, ‘an’, ‘at least’ do not denote a limitation of quantity, but rather denote the presence of at least one of the referenced item, in the sense that singular reference of an element does not necessarily exclude the plural reference of such elements. Concurrently, the term “a plurality” denotes the presence of more than one referenced items. Finally, the terms “connected” or “coupled” and related terms are used in an operational sense and are not necessarily limited to a direct connection or coupling.

Various operations may be described as multiple discrete operations in turn, in a manner that may be helpful in understanding embodiments of the present invention; however, the order of description should not be construed to imply that these operations are order dependent.

One of the present inventions notes that after the container (kettle, teakettle, teapot, etc.) is filled with water, the amount of water required for heating can be separated from the rest of the water in the container at any time. An additional aspect of the present invention is an apparatus for carrying out the invention, as shown herein.

The essence of the invention is that after the container has been filled up, the amount of water required for heating can be separated inside the container after a certain period of time.

In technical terms, the effect is the reduction of energy consumption and time, required to heat the water, which is achieved through the feature, where after some time after the container is filled up, the water inside it can be divided into a portion to be heated and the remaining unheated water.

Referring now to FIGS. 1 and 2, a kettle (or other vessel) contains a heating base 1, a lid 2, a casing 3, and an internal screen 6. To demonstrate the principals herein, FIG. 1 shows a longitudinal section of a teapot with an open screen 6 portion, and FIG. 2 shows a longitudinal section of the same teapot with a shifted and then closed screen 6.

When an entire amount of water is to be boiled, screen 6 is in the opened position (FIG. 1). Subsequently, where it is necessary to heat only part of the water in the kettle, the water is separated, by shifting and then moving screen 6 into the closed position (FIG. 2). Heating base 1 heats up the required amount of water 4 to the desired temperature. The remaining water 5 may be slowly heated slowly as a consequence of this.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. (canceled)

2. A food preparation method, wherein water or liquid food inside a container is divided after a certain amount of time into a part to be heated and a remaining part.

3. A food preparation method, wherein said food is a liquid, comprising the steps of:
placing said liquid inside a container;
said container further comprising:
a heating base, a casing defining an inner volume, a lid on said casing opposite said heating base and removably closing said inner volume;
an internal screen assembly between said heating base and said lid operative to divide said inner volume into an upper portion distant said heating base and a lower portion proximate said heating base;
said internal screen assembly further including a screen support member and an internal screen member that is operative to move between an open condition distant from said screen support member and a closed condition sealingly contacting said screen support member;
initially moving said internal screen member to said screen support member and after a certain period of time dividing said inner volume and said liquid into a heating portion and into a preserving portion; and
conducting a heating of said heating portion.
